(19) United States
(12) Patent Application Publication
(10) Pub. No.: US 2010/0304673 A1
(43) Pub. Date: Dec. 2, 2010

(54) Wireless Communication Apparatus and Wireless Communication Method

(76) Inventor: Junichi Yoshizawa, Fuchu-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/758,679

(22) Filed: Apr. 12, 2010

(30) Foreign Application Priority Data
May 29, 2009 (JP) 2009-131136

(51) Int. Cl. H04B 7/00

(52) U.S. Cl. 455/41.2

(57) ABSTRACT

According to one embodiment, a wireless communication apparatus comprises a communication module configured to execute wireless communication with a communication counterpart device, an execution module configured to execute one or more applications, and a communication controller configured to identify the communication counterpart device by wireless communication by the communication module, to select one of a transmission mode in which communication data is transmitted to the communication counterpart device and a reception mode in which communication data is received from the communication counterpart device based on an execution state of the application, to determine communication data based on data handled by the application, to determine a communication protocol based on attribute information of the data handled by the application, and to control communication with the communication counterpart device.

### CROSS-REFERENCE TO RELATED APPLICATIONS

This application is based upon and claims the benefit of priority from Japanese Patent Application No. 2009-131136, filed May 29, 2009, the entire contents of which are incorporated herein by reference.

### BACKGROUND

1. Field

One embodiment of the invention relates to a wireless communication apparatus and a wireless communication method, which execute communication by close proximity wireless transfer.

2. Description of the Related Art

In recent years, attention has been paid to a close proximity wireless transfer method, such as Felica or TransferJet. Such a close proximity wireless transfer method has been adopted in various apparatuses and systems. Compared to communication methods such as wireless LAN and Bluetooth (trademark), the close proximity wireless transfer has such a great merit that a user operation for identifying a communication counterpart is easy. For example, if devices, which support the close proximity wireless communication method, are approached sufficiently close to each other, these devices authenticate each other.

Thus, it is thought that if the close proximity wireless transfer is adopted for data transfer between a mobile device, such as a mobile phone, and a household device, such as a TV or PC, the convenience for the user is enhanced.

On the other hand, modern digital devices have many functions. For example, an up-to-date mobile phone has a call function, an Internet communication function, a music listening function, a photography function, a photo viewer function and a PIM function. Such a digital device with many functions is called “multifunction device”. With an increase in number of functions of the digital device, the digital device handles a great deal of miscellaneous data.

In order to transmit/receive desired data between multifunction devices, the following items need to be determined:

(1) Communication counterpart device,

(2) Communication protocol,

(3) Transfer data, and

(4) Data transmission/data reception.

If the close proximity wireless transfer is adopted in the multifunction device, the user operation for identifying the communication counterpart device becomes easy. However, in order to practically enhance the convenience for the user, it is to be wished that the items, other than the identification of the communication counterpart device, be easily determined. If the above items (2) to (4) are to be determined by the user's operation of the device, the load on the user is large.

Jpn. Pat. Appln. KOKAI Publication No. 2005-78193 (patent document 1) discloses a technique wherein in order to reduce the work for setting protocol information, connection using protocol information is executed until connection by protocols using all stored protocol information has failed.

However, the technique of patent document 1 requires much time until the protocol information is selected. In addition, even if the technique disclosed in patent document 1 is applied, the operations for determining the items (3) and (4) are still involved, and there remains inconvenience.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a case in which data is transferred from a first wireless communication apparatus (CPD) to a second wireless communication apparatus (APD) by close proximity wireless transfer of the first wireless communication apparatus and second wireless communication apparatus according to an embodiment of the invention;

FIG. 2 is an exemplary diagram showing a case in which data is transferred from the second wireless communication apparatus (APD) to the first wireless communication apparatus (CPD) by close proximity wireless communication of the first wireless communication apparatus and second wireless communication apparatus according to the embodiment;

FIG. 3 is an exemplary block diagram showing the structure of a communication system according to the embodiment;

FIG. 4 shows an example of a communication protocol management table in which the types of transfer data, the direction of transmission and protocols are associated;

FIG. 5 is a flow chart illustrating an example of the operation of close proximity wireless transfer of the first wireless communication apparatus (CPD);

FIG. 6 is an exemplary block diagram showing the structure of a related part of a close proximity wireless transfer module of the first wireless communication apparatus (CPD) according to the embodiment;

FIG. 7 is an exemplary view for explaining a software architecture for controlling the close proximity wireless transfer by the close proximity wireless transfer module of the first wireless communication apparatus (CPD);

FIG. 8 is an exemplary block diagram showing the functional structure of a close proximity wireless transfer control program which realizes the function of a PCL; and

FIG. 9 is an exemplary sequence diagram illustrating close proximity wireless transfer between devices.

### DETAILED DESCRIPTION

Various embodiments according to the invention will be described hereinafter with reference to the accompanying drawings. In general, according to one embodiment of the invention, a wireless communication apparatus comprises a communication module configured to execute wireless communication with a communication counterpart device, an execution module configured to execute one or more applications, and a communication controller configured to identify the communication counterpart device by wireless communication by the communication module, to select one of a transmission mode in which communication data is transmitted to the communication counterpart device and a reception mode in which communication data is received from the communication counterpart device based on an execution state of the application, to determine communication data based on data handled by the application, to determine a communication protocol based on attribute information of the data handled by the application, and to control communication with the communication counterpart device.

An embodiment of the present invention will now be described with reference to the accompanying drawings.

Each of a first wireless communication apparatus and a second wireless communication apparatus according to the embodiment of the invention has a close proximity wireless transfer function. Simply by placing the first wireless communication apparatus over the second wireless communication apparatus or by placing the second wireless communication apparatus over the first wireless communication apparatus, the data which is stored in the first wireless communication apparatus and is desired by the user can be transmitted to the second wireless communication apparatus, or the data which is stored in the second wireless communication apparatus and is desired by the user can be transmitted to the first wireless communication apparatus.

Thus, each of the first wireless communication apparatus and second wireless communication apparatus has an algorithm which uniquely determines the operation of each other's application by the combination of the following processes:

(1) Process of selecting a communication counterpart device of data transfer,

(2) Process of selecting data that is to be transferred,

(3) Process of selecting a protocol that is to be used, and

(4) Process of determining the direction of transmission/reception.

To be more specific, the above-mentioned algorithm estimates the data which is searched by the user or the data in which the user is interested, and an operation which is desired by the user, by comprehensively combining a logical device identifier, the zOrder of the application, and the focus of data.

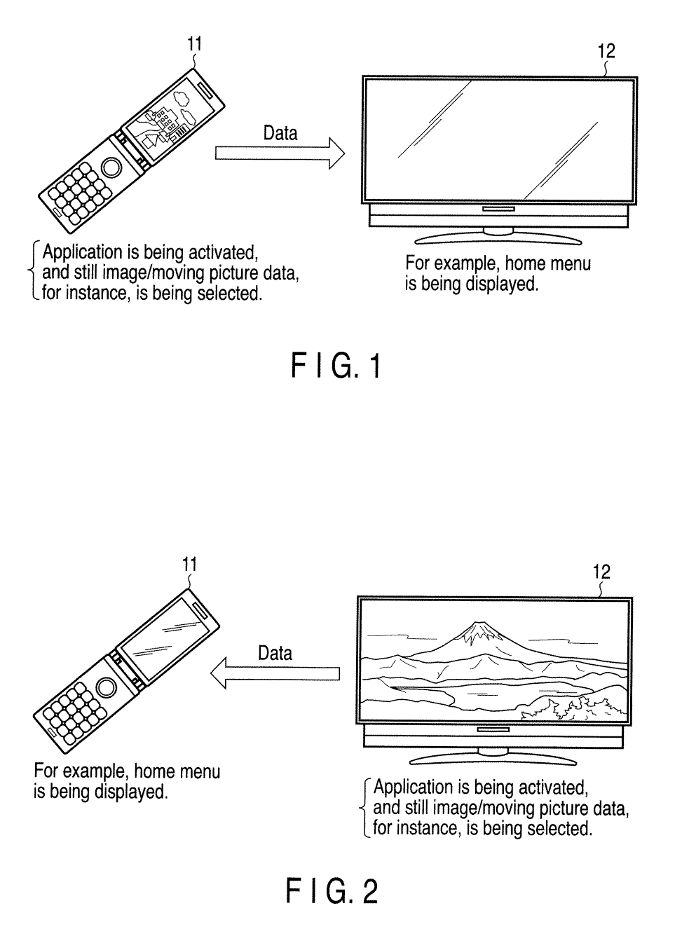

For example, as shown in FIG. 1 and FIG. 2, it is assumed that the first wireless communication apparatus is a mobile phone, and the second wireless communication apparatus is a TV. In the present embodiment, the description is given of the communication between the mobile phone and the TV. However, the present invention is not limited to the communication between the mobile phone and the TV. For example, the invention is applicable to communication between various devices, such as a mobile phone, a PDA, an audio player, a TV, a video recorder, and a personal computer. Mobile terminals, such as a mobile phone, are generally referred to as CPD (Control Point Device), and stationary terminals, such as a TV, are generally referred to as APD (Access Point Device).

For example, as shown in FIG. 1, it is assumed that a CPD 11 is starting up a first application, a second application and a third application, that the screen of the first application is on the foreground (active), the second application is on a second ground (inactive) behind the foreground, and the third application is on the background (inactive), and that still image data or moving picture data is selected by the first application (i.e. still image data or moving picture data is displayed). It is also assumed that an APD 12 displays a menu screen.

On the basis of the fact that applications are started up, that the screen of the first application is on the foreground (active), and that the still image data or moving picture data is selected by the first application (i.e. still image data or moving picture data is displayed), the CPD 11 determines transmission of still image data or moving picture data, and transmits the still data or moving picture data by a communication protocol which is suitable for the transmission of still image data or moving picture data. On the other hand, on the basis of the above condition, the APD 12 determines reception of still image data or moving picture data, and receives the still image data or moving picture data by the above-described communication protocol. The determination of the CPD 11 and APD 12 is based on the above-described algorithm.

In addition, as shown in FIG. 2, it is assumed that the APD 12 is starting up a first application, a second application and a third application, that the screen of the first application is on the foreground (active), the second application is on a second ground (inactive) behind the foreground, and the third application is on the background (inactive), and that still image data or moving picture data is selected by the first application (i.e. still image data or moving picture data is displayed). It is also assumed that the CPD 11 displays a desktop screen, or that the display of the CPD 11 is closed.

On the basis of the fact that applications are started up, that the screen of the first application is on the foreground (active), and that the still image data or moving picture data is selected by the first application (i.e. still image data or moving picture data is displayed), the APD 12 determines transmission of still image data or moving picture data, and transmits the still data or moving picture data by a communication protocol which is suitable for the transmission of still image data or moving picture data. On the other hand, on the basis of the above condition, the CPD 11 determines reception of still image data or moving picture data, and receives the still image data or moving picture data by the above-described communication protocol. The determination of the CPD 11 and APD 12 is based on the above-described algorithm.

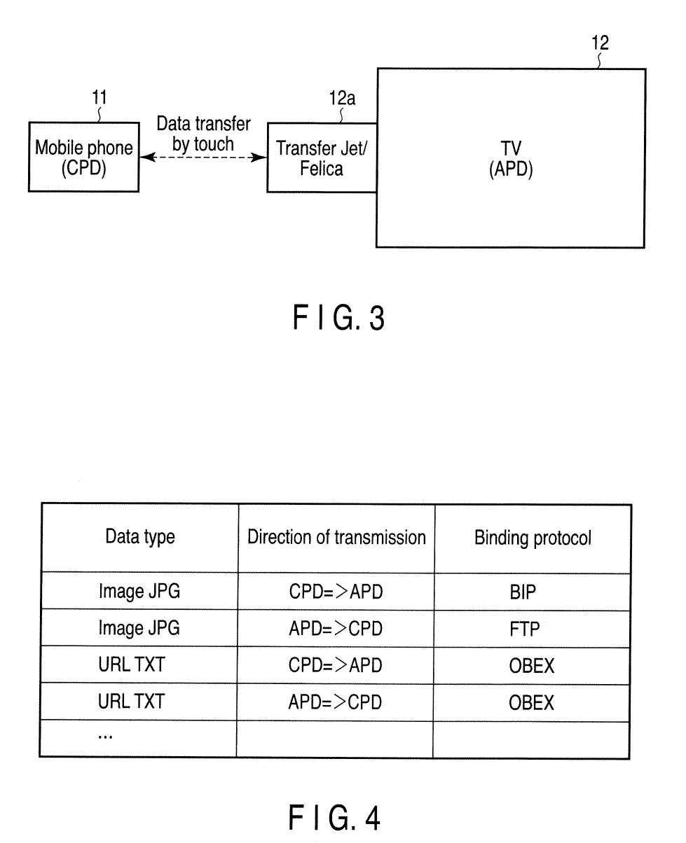

FIG. 3 is an exemplary block diagram showing the structure of a communication system according to the embodiment. The communication system comprises the CPD 11 and APD 12. The CPD 11 includes a close proximity wireless transfer module, and executes data transfer with another communication apparatus (e.g. APD 12) by this close proximity wireless transfer module. The APD 12 also includes a close proximity wireless transfer module, and executes data transfer with another communication apparatus (e.g. CPD 11) by this close proximity wireless transfer module.

For example, the user performs such an operation as holding the CPD 11 over a communication area 12a of the APD 12 or placing the CPD 11 at the communication area 12a, thereby generating a trigger of data transfer for the CPD 11 and APD 12.

In general, in order to execute data transfer between two devices, at least the following items (1) to (4) need to be identified or determined.

(1) Identification of Communication Counterpart

An Internet-capable terminal, for instance, identifies a communication counterpart by making use of an IP address or by indirectly using a name space such as DNS. (2) Determination of Communication Data

In the case where a great deal of miscellaneous data are stored, the user determines which of the data is to be selected as communication data.

(3) Determination of Communication Protocol

The device determines which of protocols is to be used in order to transfer communication data. For example, in the Internet, TCP/UDP is switched in accordance with the kind of application. In the Bluetooth (trademark), photo data can be transmitted by FTP (File Transfer Protocol) or by BIP (Basic Imaging Profile).

(4) Determination of Direction of Communication

The device selects one of a transmission mode for transmitting communication data and a reception mode for receiving communication data.

Each of the CPD 11 and APD 12 according to the embodiment includes algorithms for uniquely determining the above items (1) to (4). The algorithms will be described below.

(1) Communication Counterpart Selection Algorithm

Each of the CPD 11 and APD 12 according to the embodiment includes a close proximity wireless transfer module of a technology such as Felica or TransferJet, and selects a communication counterpart by this close proximity wireless transfer module. To be more specific, this algorithm is realized by the close proximity wireless transfer technology such as Felica or TransferJet.

(2) Communication Data Selection Algorithm

For example, in the case where applications are being started, the data that is displayed (selected) by an application, which is positioned as a top application, is selected as communication data. By this selection method, the data, in which the user is interested, can be selected as communication data. Generally speaking, the data in which the user is interested is the currently displayed data.

Alternatively, communication data is selected by a data specifying algorithm within an application.

For example, in the case where an application handles a single data type, the data which is focused is selected as communication data. For example, in the case where one photo data is selected (displayed), this photo data is selected as communication data. If no specific data is focused, all data which are being handled by the application are selected as communication data. For example, in the case where titles of plural photo data are displayed in a list form, all the photo data of the listed titles are selected as communication data.

In the case where the application is handling plural data types, attribute information of the data that is handled is selected as communication data. For example, in the case where the application selects and displays a Web page, a URL indicating the site of this Web page is selected as communication data. The Web page includes a plurality of data, such as text/moving picture/still images. These plural data may be transmitted as communication data to the communication counterpart device.

(3) Transmission/Reception Direction Selection Algorithm

For example, in the case where the user is to transmit the data stored in the CPD 11 to the APD, the user operates the CPD 11, views the data stored in the CPD 11, and selects transmission data from the viewed data. The CPD 11 detects such an operation and selects the direction of transmission/reception.

For example, the CPD 11 physically determines the operation state and selects the direction of transmission/reception. If the CPD 11 is a mobile phone, the user opens/closes the body or display of the mobile phone or slides the body or display, in the case of operating the mobile phone. Thus, the CPD 11 can detects whether the mobile phone is in the operation state or not, on the basis of the state of the clam shell or the state of slide. In another case, the user presses keys of the mobile phone while operating the mobile phone. The CPD 11 can detect whether the mobile phone is in operation or not, on the basis of the elapsed time from the last operation of keys. In the case where it is determined that the mobile phone is in operation, the transmission mode is selected between the transmission mode and the reception mode, and transfer data is transmitted to the communication counterpart device.

Alternatively, the CPD 11 selects the direction of transmission/reception, on the basis of the state of top application. If the CPD 11 is in a home menu display state, the CPD 11 determines a non-operation state, selects a reception mode, and receives transfer data from the communication counterpart device. If the CPD 11 is in the state of executing a specific application, the CPD 11 determines an operation state, selects the transmission mode, and transmits the transfer data to the communication counterpart device.

Alternatively, the CPD 11 may store a transmission/reception table showing the correspondency between applications and the transmission mode/reception mode, and may execute the transmission mode or the reception mode, on the basis of the transmission/reception table and the application that is being started up. For example, assume that the transmission/reception table has the association between a first application and a transmission mode, and the association between a second application and a reception mode. The CPD 11 selects the transmission mode on the basis of the startup of the first application, and selects the reception mode on the basis of the startup of the second application.

(4) Communication Protocol Selection Algorithm

The communication protocol is uniquely selected in accordance with the Mime-Type of transfer data. For example, as shown in FIG. 4, the CPD 11 stores a communication protocol management table in which the types of transfer data, the direction of transmission and protocols are associated. The CPD 11 can uniquely select the communication protocol from this communication protocol management table and the type of transfer data.

The CPD 11 combines the above-described algorithms and uniquely estimates the data which the user intends to transfer, thus being able to transfer the data which the user intends to transfer.

In the above description, the algorithms of the CPD 11 have been explained. The APD 12 includes the same algorithms.

Next, examples of selection of the above-described algorithms are described.

(1) Case in which Photo Data of the CPD 11 is Transferred to the APD 12

For example, by the user operation, the CPD 11 starts up the application corresponding to photo data. The startup application designates the photo data, and the photo data is displayed. In other words, this photo data is focused. By the above-described algorithms, the CPD 11 selects the transmission mode, selects the photo data as transfer data, selects the communication protocol (BIP) corresponding to the Mime-Type (JPG IMG) of the photo data, and transmits the photo data to the communication counterpart device (APD 12) by the selected communication protocol.

(2) Case in which Video Data of the APD 12 is Transferred to the CPD 11

For example, it is assumed that the CPD 11 is in a home menu display state. In addition, the APD 12 starts up the application which displays a moving picture list. The moving picture list is displayed, and a predetermined moving picture in the moving picture list is designated. In other words, this predetermined moving picture is focused. The CPD 11 selects the reception mode by the above-described algorithm. By the above-described algorithms, the APD 12 selects the transmission mode, selects the predetermined moving picture as transfer data, selects the communication protocol (FTP) corresponding to the Mime-Type (JPG MPG) of the moving picture data, and transmits the moving picture data to the communication counterpart device (CPD 11) by the selected communication protocol.

(3) Case in which a Web Page, which is Displayed on the CPD 11, is Transferred to the APD 12

For example, by the user operation, the CPD 11 stats up the browser, designates the Web page, and displays the Web page. By the above-described algorithms, the CPD 11 selects the transmission mode, selects the URL of the Web page as transfer data, selects the communication protocol (OBEX) corresponding to the Mime-Type (URL txt) of the URL, and transmits the URL to the communication counterpart device (APD 12) by the selected communication protocol. By the above-described algorithms, the APD 12 selects the reception mode, receives the URL, and displays the Web page on the basis of the received URL.

There may be a case in which the above-described algorithms fail to meet the user's need. In such a case, the user can customize the algorithms. The above description is directed to the case in which the transmission/reception of desired data is completed by simply placing the CPD 11 over the APD 12 (without the user's operation). Alternatively, it is possible to accept a user operation during this process, thereby executing a process which more exactly meets the user's need.

Thereby, when data transfer is executed between multifunction devices with use of point-to-point type close proximity wireless transfer, the data that is desired by the user can be transferred by only an intuitive operation, without an additional operation by the user.

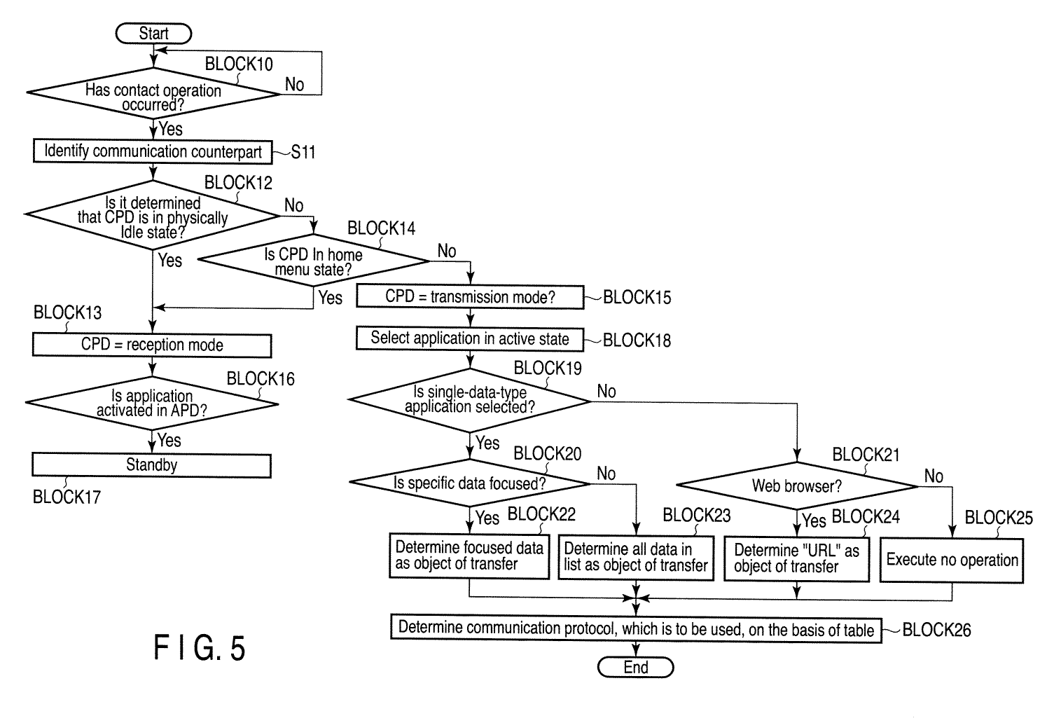

Next, referring to a flow chart of FIG. 5, the operation of the CPD 11 is described. If the CPD 11 and APD 12 come in contact (BLOCK 10), the CPD 11 identifies the communication counterpart (BLOCK 11). The identification of the communication counterpart will be described later in greater detail. If the CPD 11 is in a physically idle state (BLOCK 12, YES), the CPD 11 selects the reception mode (BLOCK 13). Even in the case where the CPD 11 is not in the physically idle state (BLOCK 12, NO), if the CPD 11 is in the home menu display state (BLOCK 14, YES), the CPD 11 selects the reception mode (BLOCK 13). If the APD 12, which is the communication counterpart of the CPD 11, is starting up an application (BLOCK 16, YES), the CPD 11 stands by in the reception mode (BLOCK 17).

If the CPD 11 is neither in the physically idle state (BLOCK 12, NO) nor in the home menu display state (BLOCK 14, NO), the CPD 11 selects the transmission mode (BLOCK 15). This state, for example, is such a state that the CPD 11 is starting up an application. In the case where the CPD 11 is starting up applications, one of the applications is selected on the basis of the zOrder of each application. In other words, the application in the active state is selected (BLOCK 18).

If the selected application is an application which handles a single data type (BLOCK 19, YES) and the application selects data (BLOCK 20, YES), the CPD 11 determines the data, which is selected by the application, as the object of transfer (BLOCK 22), selects the communication protocol suitable for the object of transfer, on the basis of the communication protocol management table (BLOCK 26), and transmits the data that is the object of transfer.

If the selected application is an application which handles a single data type (BLOCK 19, YES) and the application selects (displays) a data list or the like (BLOCK 20, NO), the CPD 11 determines all the data in the data list, which is selected by the application, as the object of transfer (BLOCK 23), selects the communication protocol suitable for the object of transfer, on the basis of the communication protocol management table (BLOCK 26), and transmits the data that is the object of transfer.

If the selected application is not an application which handles a single data type (BLOCK 19, NO) and the selected application is a Web browser (BLOCK 21, YES), the CPD 11 determines the URL, which is indicative of the Web page displayed by the Web browser, as the object of transfer (BLOCK 24), selects the communication protocol suitable for the object of transfer (BLOCK 26), and transmits the data that is the object of transfer.

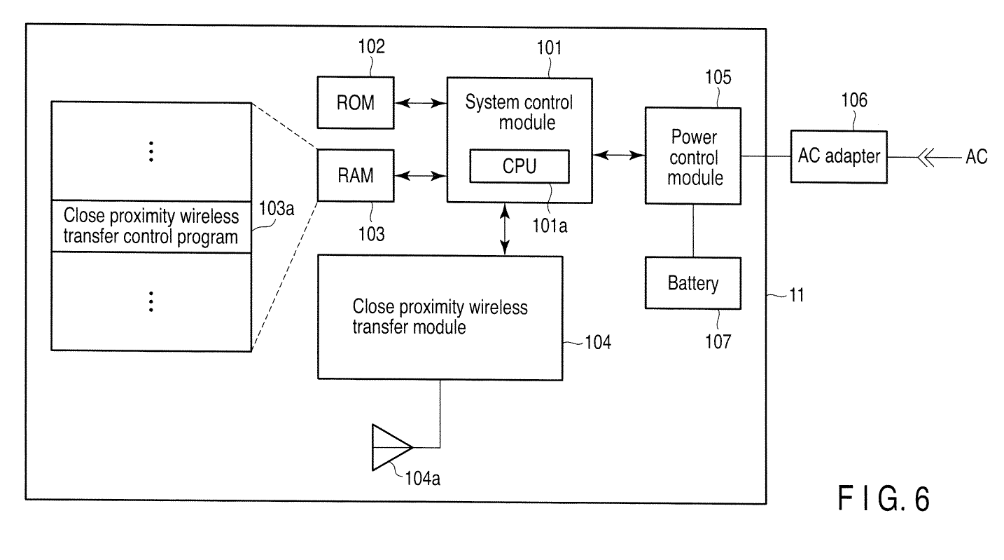

Next, referring to FIG. 6 to FIG. 9, a detailed description is given of the close proximity wireless transfer, and the structure for realizing the above-described algorithms.

FIG. 6 is an exemplary block diagram showing the structure of a related part of a close proximity wireless transfer module of the first wireless communication apparatus (CPD 11) according to the embodiment of the invention. This structure is substantially the same as the structure of the related part of the close proximity wireless transfer module of the second wireless communication apparatus (APD 12) according to the embodiment.

The CPD 11 comprises a system control module (a system controller) 101, a ROM 102, a RAM 103, a close proximity wireless transfer module 104, a power control module (a power controller) 105, an AC adapter 106 and a battery 107.

The system control module 101 controls the operations of the respective parts of the CPD 11. The system control module 101 includes a CPU 101a and is connected to the ROM 102, RAM 103, close proximity wireless transfer module 104 and power control module 105.

The CPU 101a is a processor which loads instructions and data, which are stored in the ROM 102, into the RAM 103, and executes various processes. A close proximity wireless transfer control program 103a for controlling close proximity wireless transfer is loaded in the RAM 103. The CPU 101a executes the close proximity wireless transfer control program 103a which is loaded in the RAM 103, and controls the close proximity wireless transfer module 104.

The close proximity wireless transfer module 104 executes close proximity wireless transfer. The close proximity wireless transfer module 104 establishes wireless connection with an external device (e.g. APD 12) having a close proximity wireless transfer function, which is present within a predetermined distance from the close proximity wireless transfer module 104, and starts transmission of data such as a file. The close proximity wireless transfer between the close proximity wireless transfer module 104 and the external device is executed in a peer-to-peer mode. The communication distance is, e.g. 3 cm. The wireless communication between the close proximity wireless transfer module 104 and the external device is enabled only in the case where the close proximity wireless transfer module 104 and the external device are in a close proximity state, that is, only in the case where the distance between the close proximity wireless transfer module 104 and the external device has decreased to the communication distance (e.g. 3 cm) or less. When the close proximity wireless transfer module 104 and the external device have approached within the communication range, the wireless connection between the close proximity wireless transfer module 104 and the external device is established. In accordance with the transmission/reception direction, the transfer data and the communication protocol, which are selected by the above-described algorithms, the communication between the close proximity wireless transfer module 104 and the external device is executed.

In the close proximity wireless transfer, an induction electric field is used. For example, TransferJet is usable as the close proximity wireless transfer method. TransferJet is a close proximity wireless transfer method using UWB, and can realize high-speed data transfer.

The close proximity wireless transfer module 104 is connected to an antenna 104a. The antenna 104a is an electrode which is called “coupler”, and executes data transmission/reception to/from the external device by a radio signal using an induction electric field. When the external device approaches within the communication distance (e.g. 3 cm) from the antenna 104a, the antennas (couplers) of the close proximity wireless transfer module 104 and the external device are coupled by the induction electric field, and thereby the wireless communication between the close proximity wireless transfer module 104 and the external device can be executed. The close proximity wireless transfer module 104 and the antenna 104a can be realized as a single module.

The power control module 105 supplies power to the respective components of the CPD 11 by using power which is supplied from the outside via the AC adapter 106 or power which is supplied from the battery 107. In other words, the CPD 11 is driven by an external power supply such as an AC commercial power supply, or by the battery 107. The AC adapter 106 may be provided within the CPD 11.

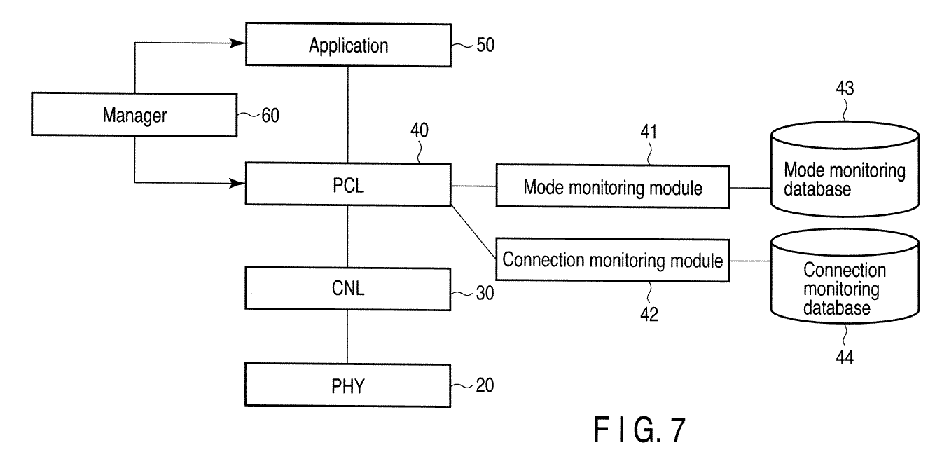

Next, referring to FIG. 7, a description is given of the software architecture for controlling the close proximity wireless transfer which is executed by using the close proximity wireless transfer module 104.

The software architecture shown in FIG. 7 has a hierarchical structure of a protocol stack for controlling close proximity wireless transfer. The protocol stack comprises a physical layer (PHY) 20, a connection layer (CNL) 30, a protocol conversion layer (PCL) 40, and an application layer 50. For example, the connection layer (CNL) 30, protocol conversion layer (PCL) 40 and application layer 50 can be realized by the transfer control program 103a.

The physical layer (PHY) 20 is a layer for controlling physical data transfer, and corresponds to a physical layer in an OSI reference model. A part or all of the functions of the physical layer (PHY) 20 can be realized by using hardware within the close proximity wireless transfer module 104.

The physical layer (PHY) 20 converts data from the connection layer (CNL) 30 to a radio signal. The connection layer (CNL) 30 corresponds to a data link layer and a transport layer within the OSI reference model, and executes data communication by controlling the physical layer (PHY) 20. Responding to a connection request from the protocol conversion layer (PCL) 40 or a connection request from the external device, the connection layer (CNL) 30 executes a process of establishing connection (CNL connection) between the close proximity wireless transfer module 104 and the external device which are set in the close proximity state.

The protocol conversion layer (PCL) 40 corresponds to a session layer and a presentation layer in the OSI reference model, and is positioned between the application layer 50 and the connection layer (CNL) 30 for controlling the establishment and release of connection between devices A and B. The protocol conversion layer (PCL) 40 executes control of each application (communication program) within the application layer 50 and control of the connection layer (CNL) 30.

To be more specific, the protocol conversion layer (PCL) 40 executes a conversion process for converting the data (user data) corresponding to the application protocol (e.g. SCSI, OBEX, or other general-use protocol), which is handled by each communication program of the application layer 50, to a specific transmission data format. By this conversion process, whichever communication program is used when data is transmitted/received, the data can be converted to a packet (data of a specific transmission data format) which can be handled by the connection layer (CNL) 30. This protocol conversion layer (PCL) 40 makes it possible to use various application protocols in the close proximity wireless transfer.

In addition, the protocol conversion layer (PCL) 40 executes a process of exchanging service information (information indicative of services which can be provided by each device) and session information (information relating to a session that is the object of connection establishment/release) with the communication counterpart device, and also executes startup of the application, management of connection, and management of sessions.

The application layer 50 includes communication programs (applications) corresponding to some application protocols, such as SCSI, OBEX, and other general-use protocols. Each application executes a process of issuing a request for the start/end of a session to the protocol conversion layer (PCL) 40, and a process of transmitting/receiving data via the protocol conversion layer (PCL) 40.

The protocol conversion layer (PCL) 40 comprises, for example, a mode monitoring module 41, a connection monitoring module 42, a mode monitoring database 43 and a connection monitoring database 44.

The connection monitoring module 42 monitors connection (CNL connection) between the CPD 11 and the external device, which are set in the close proximity state. As has been described above, responding to a connection request from the PCL 40 or a connection request from the external device, the CNL 30 executes a process of establishing connection between the CPD 11 and the external device which are set in the close proximity state. In addition, the connection between the CPD 11 and the external device is released in accordance with a connection release request by the user or in accordance with the release of the close proximity state, which occurs when the CPD 11 and the external device are separated. The connection monitoring module 42 monitors the establishment of connection and the release of connection, and stores in the connection monitoring database 44 the information which is indicative of the establishment of connection between the CPD 11 and the external device or the release of connection between the CPD 11 and the external device.

The mode monitoring module 41 monitors the mode which is set in the PCL 40. One of a proactive mode, a reactive mode and a flexible mode is set in the PCL 40.

The proactive mode is a mode in which a service start request is sent from the CPD 11 to the external device. The device, which is set in the proactive mode, functions as a so-called master, and this device controls the communication counterpart device and can execute a service such as data transfer between the devices. The reactive mode is a mode in which the CPD 11 receives a service start request which is sent from the external device. The device, which is set in the reactive mode, functions as a so-called slave, and can execute, under the control of the communication counterpart device, a service such as data transfer between the devices.

The default mode of a portable device, such as a mobile phone, which cannot be driven by an external power supply, is set to be the reactive mode in order to reduce the power consumption. In the case where the user has operated an application running on the portable device, the portable device automatically transitions from the reactive mode to the proactive mode.

The device, which is set in the proactive mode, transmits a connection request signal. On the other hand, since the device in the reactive mode does not transmit a connection request signal, the power consumption thereof is relatively low.

The flexible mode is a mode which transitions to either the proactive mode or the reactive mode, in accordance with the mode (proactive mode or reactive mode) which is set in the external device that is in the close proximity state. By the negotiation with the external device that is in the close proximity state, the CPD 11 that is set in the flexible mode transitions to the reactive mode in the case where the external device is in the proactive mode, and transitions to the proactive mode in the case where the external device is in the reactive mode. In other words, the function of the CPD 11 that is set in the flexible mode is switched between the function as a master and the function as a slave, in accordance with the mode that is set in the communication counterpart device. The transition to the proactive mode or the reactive mode is executed, for example, after the connection between the devices is established.

The default mode that is set in a device, such as a personal computer, which can be driven by an external power supply such as an AC adapter power supply, is the flexible mode. The device, which is set in the flexible mode, transmits a connection request signal. Thereby, even in the case where the user approaches the mobile phone to the close proximity of the personal computer (device in the flexible mode) without operating the application of the mobile phone, the connection between these devices can be established, and a service, such as transfer of a data file, can be provided to the user under the control of the personal computer.

In the case where a service is to be executed between the device that is set in the proactive mode (the device that has transitioned to the proactive mode) and the device that is set in the reactive mode (the device that has transitioned to the reactive mode), a service, which is designated by the device that is set in the proactive mode, is executed between these two devices. When the execution of the service is finished, the device, which has transitioned from the reactive mode to the proactive mode, restores to the reactive mode, and the device, which has transitioned from the flexible mode to the proactive mode, or the device, which has transitioned from the flexible mode to the reactive mode, restores to the flexible mode.

The mode monitoring module 41 stores the information, which is indicative of the current mode of the PCL 40, in the mode monitoring database 43. Thus, in the case where the PCL 40 of the CPD 11 has transitioned from the flexible mode to the proactive mode or the reactive mode by the negotiation with the external device that is set in the close proximity state, the mode monitoring database 43 is rewritten with the information indicative of either the proactive mode or the reactive mode, to which the PCL 40 of the CPD 11 has transitioned.

In the PCL 40, the connection (CNL connection) between the CPD 11 and the external device and the mode that is set in the PCL 40 are monitored, and the control of each application (communication program) within the application layer 50 and the control of the CNL 30 are executed.

A manager 60 is connected to the above-described PCL 40 and application layer 50. The manager 60 controls the close proximity wireless transfer on the basis of the above-described algorithms (communication counterpart selection algorithm, communication data selection algorithm, transmission/reception direction selection algorithm and communication protocol selection algorithm). For example, as has been described above, one of the transmission mode and reception mode is selected on the basis of the algorithm. In other words, one of the proactive mode, reactive mode and flexible mode is set on the basis of the algorithm. The condition for setting one of the proactive mode, reactive mode and flexible mode, which are described in the present embodiment, is included in the above-described algorithms.

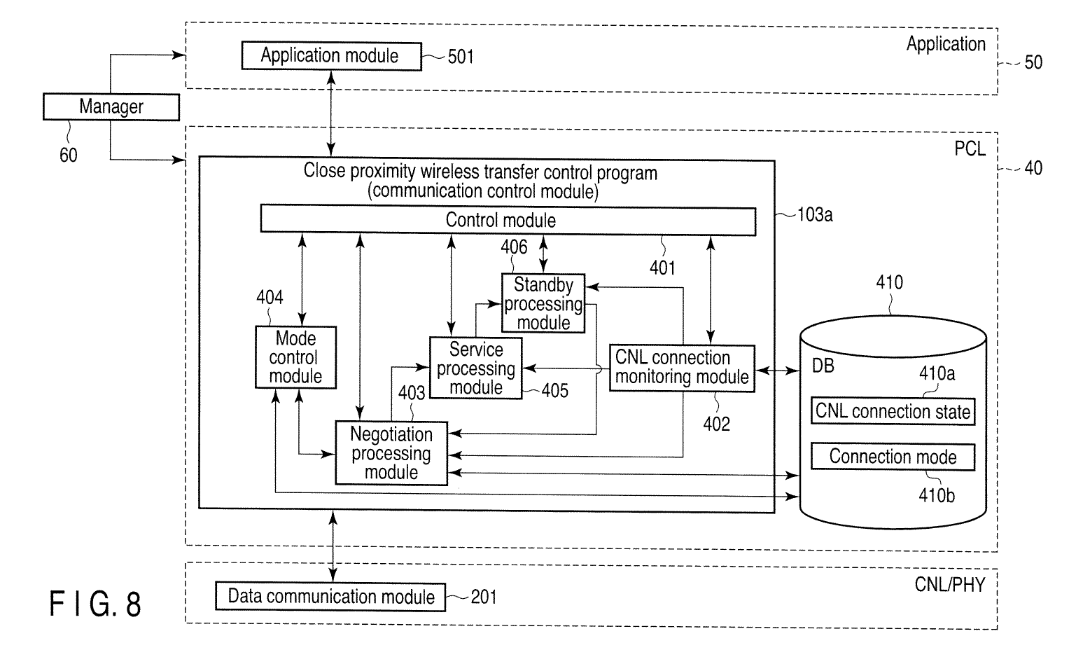

FIG. 8 is a block diagram showing an example of the functional structure of the close proximity wireless transfer control program 103a which realizes the function of the above-described PCL 40.

As shown in FIG. 8, the close proximity wireless transfer control program 103a comprises a control module (a controller) 401, a CNL connection monitoring module 402, a negotiation processing module (a negotiation processor) 403, a mode control module (a mode controller) 404, a service processing module (a service processor) 405, and a standby processing module (a standby processor) 406. The close proximity wireless transfer control program 103a is connected to a database 410. The database 410 is a storage device which stores a CNL connection state 410a which is information indicative of the connection state between the CPD 11 and the external device, and a connection mode 410b which is information indicative of the connection mode that is set in the PCL 40 of the CPD 11 and the connection mode that is set in the PCL of the external device.

The control module 401 controls a communication sequence of communication between the CPD 11 and the external device. Specifically, the control module 401 controls the respective components in the close proximity wireless transfer control program 103a in accordance with requests or notices by an application module 501 corresponding to the application layer 50 and by a data communication module 201 corresponding to the CNL 30 and physical layer (PHY) 20.

The CNL connection monitoring module 402 monitors the connection (CNL connection) between the CPD 11 and the external device by the CNL 30. In the case where the connection between the close proximity wireless transfer module 104 and the external device by the CNL 30 has been established, the CNL connection monitoring module 402 stores information, which is indicative of the establishment of CNL connection, in the CNL connection state 410a of the database 410. In addition, in the case where the connection between the close proximity wireless transfer module 104 and the external device by the CNL 30 has been released, the CNL connection monitoring module 402 stores information, which is indicative of the release of CNL connection, in the CNL connection state 410a of the database 410.

The CNL connection monitoring module 402 reports the establishment or release of CNL connection to the respective components of the close proximity wireless transfer control program 103a. Upon receiving the report on the release of CNL connection, the negotiation processing module 403, mode control module 404, service processing module 405 and standby processing module 406 interrupt processes which are being executed. In other words, the processes by the negotiation processing module 403, mode control module 404, service processing module 405 and standby processing module 406 are executed while the CNL connection is being established.

When the negotiation processing module 403 has received the report on the establishment of CNL connection from the CNL connection monitoring module 402, the negotiation processing module 403 executes a negotiation process. The negotiation processing module 403 executes, as the negotiation process, mediation of the mode that is to be set in the PCL 40, determination of the service that is to be executed between the devices, and synchronization of the service.

In the mediation of the mode that is set in the PCL 40, the negotiation processing module 403 determines the mode that is to be set in the PCL 40 of the CPD 11, in accordance with the mode that is set in the communication counterpart device. In the PCL 40, as described above, one of the proactive mode, reactive mode and flexible mode is set. In the case where a service is executed between two devices, one of the two devices needs to be set in the proactive mode in which this one device transmits a service start request to the communication counterpart device, and the other device needs to be set in the reactive mode in which this other device receives and responds to the service start request.

In the case where the PCL 40 of the own device is set in the proactive mode and the PCL 40 of the communication counterpart device is set in the reactive mode, or in the case where the PCL 40 of the own device is set in the reactive mode and the PCL 40 of the communication counterpart device is set in the proactive mode, the negotiation processing module 403 does not execute the process of altering the mode that is set in the PCL 40.

In the case where the PCL 40 of the own device is set in the flexible mode, the negotiation processing module 403 selects either the proactive mode or the reactive mode in accordance with the mode that is set in the PCL 40 of the communication counterpart device. Specifically, in the case where the PCL 40 of the communication counterpart device is set in the proactive mode, the negotiation processing module 403 selects the reactive mode as the mode that is to be set in the PCL 40 of the own device. In the case where the PCL 40 of the communication counterpart device is set in the reactive mode, the negotiation processing module 403 selects the proactive mode as the mode that is to be set in the PCL 40 of the own device. The negotiation processing module 403 informs the mode control module 404 of the selected mode.

The mode control module 404 cooperates with the negotiation processing module 403 and controls the mode that is to be set in the PCL 40. The mode control module 404 sets in the PCL 40 the mode that has been determined by the negotiation processing module 403.

The information, which is indicative of the mode that is set in the PCL 40 of the own device and the mode that is set in the PCL 40 of the communication counterpart device, is stored in the connection mode 410b of the database 410.

In the determination of a service that is to be executed between the devices, the negotiation processing module 403 determines a service, which is designated by the device in which the PCL 40 is set in the proactive mode, as the service that is to be executed between the devices. Accordingly, in the case where the communication counterpart device is set in the proactive mode, the negotiation processing module 403 determines a service, which is designated by the communication counterpart device, as the service that is to be executed between the devices. In the case where the PCL 40 of the own device is set in the proactive mode, the negotiation processing module 403 determines a service corresponding to the application that is designated by the user, or a predetermined service, as the service that is to be executed between the devices.

In the synchronization of the service, the negotiation processing module 403 executes a synchronization process for starting the execution of the service between the devices.

After the synchronization (start) of the service by the negotiation processing module 403 has been executed, the service processing module 405 executes the process corresponding to the service that is determined by the negotiation processing module 403. The service processing module 405 executes the process by properly controlling the data communication module 201 and the application module 501.

The standby processing module 406 executes a standby process during a time period from the completion of the process by the service processing module 405 to the reception of a new service start request. The standby processing module 406 finishes the standby process in the case where the standby processing module 406 has received a service start request from the communication counterpart device, or in the case where a service start request has been input by the user. In reply to the end of the standby process by the standby processing module 406, the negotiation process by the negotiation processing module 403 is started once again. Specifically, the standby processing module 406 does not issue a request for the start of the negotiation process to the negotiation processing module 403, during the time period from the completion of the process by the service processing module 405 to the reception of the service start request from the communication counterpart device, or during the time period from the completion of the process by the service processing module 405 to the input of the service start request by the user.

The application module 501 manages applications (communication programs) which execute data transmission/reception by using close proximity wireless transfer. The application module 501 executes a process of informing the close proximity wireless transfer control program 103a of a session start/end request from the application, and executes a process of controlling the close proximity wireless transfer control program 103a. The applications are communication programs corresponding to some application protocols, such as SCSI, OBEX, and other general-use protocols.

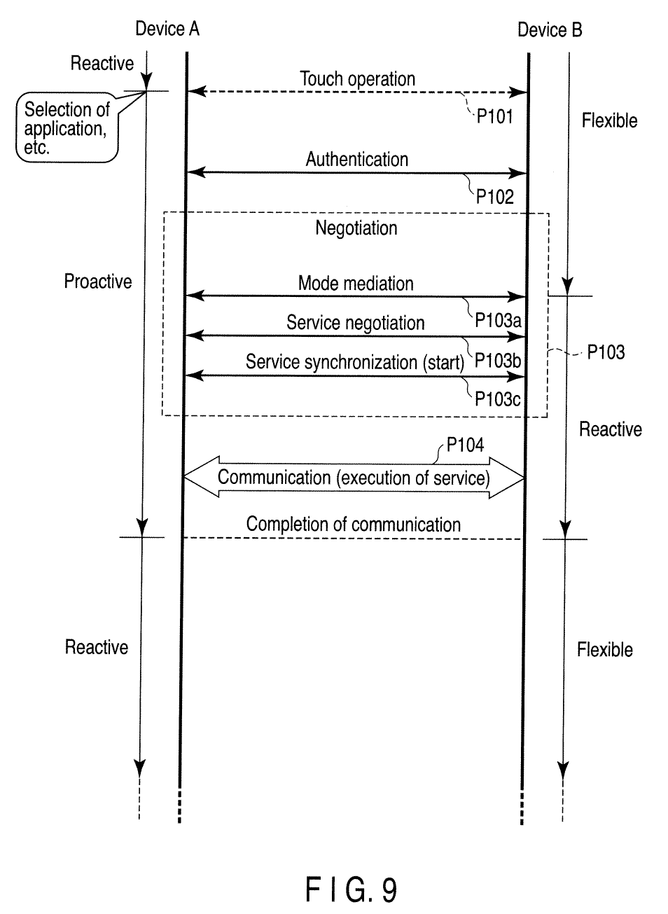

FIG. 9 is an exemplary sequence diagram illustrating an example of close proximity wireless transfer between devices. It is assumed that a service start request is transmitted from a device A (e.g. CPD 11), which is set in the proactive mode, to a device B (APD 12) which is set in the flexible mode. For example, in the initial state, it is assumed that the device A is set in the reactive mode and the device B is set in the flexible mode.

To start with, the user selects on the device A an application program which executes close proximity wireless transfer, and brings the device A and device B close to each other (touch operation) in a close proximity state (P101). The device A, in which the application program has been selected, transitions from the reactive mode in which a service start request is received from the external device, to the proactive mode in which a service start request is transmitted to the external device.

The transition to the proactive mode is executed by the above-described transmission/reception direction selection algorithm on the condition of the selection (startup) of the application program. The condition for the transition to the proactive mode is not limited to the selection of the application program. For example, if the device A is a mobile phone, the transition to the proactive mode is executed by the above-described transmission/reception direction selection algorithm on the condition of the detection of an operation of opening the display of the mobile phone, the detection of an operation of sliding the display of the mobile phone, or the detection of non-passage of a predetermined time from a key operation of the mobile phone.

Next, the device A and device B execute a process (authentication process) for establishing connection (CNL connection) between the device A and device B (P102). For example, the device A sends a connection request. The device B, which has received the connection request, sends a response to the connection request to the device A. By the above process, the connection between the device A and device B is established. The establishment of connection is executed according to the above-described communication counterpart selection algorithm.

The device A and device B, which have established the connection, execute a negotiation process (P103). The device A and device B execute, as the negotiation process, mode mediation (P103a), service negotiation (P103b) and service synchronization (P103c).

Specifically, according to the above-described transmission/reception direction selection algorithm, the device B, which is set in the flexible mode, executes mode mediation to transition its own mode in accordance with the mode which is set in the device A that is the communication counterpart device (P103a). In this case, since the device A is set in the proactive mode, the device B transitions its own mode from the flexible mode to the reactive mode. According to the above-described communication data selection algorithm, the device A and device B executes the service negotiation for determining the service which is to be executed between the device A and device B (P103b). In this case, the service which is designated by the device A that is set in the proactive mode, that is, the service corresponding to the application program which has been selected by the user, is determined as the service which is to be executed between the device A and device B. For example, if there is still image data or moving picture data which is selected by the application program, the process of transmitting the still image data or moving picture data from the device A to the device B is determined as the service. Further, according to the communication protocol selection algorithm, the communication protocol, which is suitable for the transmission of still image data or moving picture data is selected on the basis of the communication protocol management table. Besides, the device A and device B execute service synchronization for executing the determined service (P103c). Thereby, the execution of the service between the device A and device B is started.

If the above negotiation process is completed, the service is executed between the device A and device B, and the communication, such as data transmission/reception, is executed (P104). If the execution of the service is completed, the device A transitions from the proactive mode to the reactive mode, and the device B transitions from the reactive mode to the flexible mode. In addition, the connection between the device A and device B is released.

The various modules of the device described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a communication module configured to execute wireless communication with a communication counterpart device;
an execution module configured to execute one or more applications; and
a communication controller configured to identify the communication counterpart device by wireless communication by the communication module, to select one of a transmission mode in which communication data is transmitted to the communication counterpart device and a reception mode in which communication data is received from the communication counterpart device based on an execution state of the application, to determine communication data based on data handled by the application, to determine a communication protocol based on attribute information of the data handled by the application, and to control communication with the communication counterpart device.

2. The apparatus of claim 1, wherein the communication controller is configured to determine selection of the transmission mode based on a startup state of the application.

3. The apparatus of claim 1, wherein the communication controller is configured to determine data selected by the application, as the communication data.

4. The apparatus of claim 1, wherein the communication controller is configured to determine data selected by an active state application of startup state applications, as the communication data.

5. The apparatus of claim 1, wherein the communication controller is configured to determine a URL of a Web page selected by the application, as the communication data.

6. The apparatus of claim 1, wherein the communication controller is configured to store a communication protocol management table, which is configured such that a first kind of communication data is transmitted by a first communication protocol and a second kind of communication data is transmitted by a second communication protocol, and to determine the communication protocol based on the kind of communication data and the communication protocol management table.

7. A wireless communication method comprising:
identifying a communication counterpart device by executing wireless communication with the communication counterpart device;
selecting one of a transmission mode in which communication data is transmitted to the communication counterpart device and a reception mode in which communication data is received from the communication counterpart device based on an execution state of an application;
determining communication data based on data which is handled by the application;
determining a communication protocol based on attribute information of the data which is handled by the application; and
controlling communication with the communication counterpart device.
